(19) United States
(12) Patent Application Publication
(10) Pub. No.: US 2021/0031211 A1
(43) Pub. Date: Feb. 4, 2021

(54) MAGNET APPARATUS

(71) Applicant: Giamag AS, Kjeller (NO)

(72) Inventor: Henrik HØYER, Kjeller (NO)

(21) Appl. No.: 16/980,564

(22) PCT Filed: Mar. 8, 2019
(86) PCT No.: PCT/EP2019/055926

§ 371 Date: Sep. 14, 2020

(30) Foreign Application Priority Data
Mar. 15, 2018 (GB) 1804189.7

(51) Int. Cl. B03C 1/033; H01F 7/02

(52) U.S. Cl. CPC B03C 1/0332; B03C 2201/18; B03C 2201/22; H01F 7/0273

(57) ABSTRACT

There is provided a magnet apparatus for generating a high gradient and/or high strength magnetic field. The magnet apparatus comprises: a first plurality of magnets (110) disposed in a first layer (101) and generating a first magnetic field. Each magnet (110) of the first plurality is adjacent at least one other magnet (110) of the first plurality, and each magnet of the first plurality has a magnetic field polarity (120) that is rotated with respect to that of the adjacent magnet (110) of the first plurality. The magnet apparatus also comprises a second plurality of magnets (140) disposed in a second layer (102) and generating a second magnetic field. Each magnet (140) of the second plurality is adjacent a magnet (110) of the first plurality, and each magnet (140) of the second plurality has a magnetic field polarity (120) that is rotated with respect to that of the closest magnet (140) of the second plurality. The second magnetic field combines with the first magnetic field to create a magnetic field peak having a larger gradient than that of the first magnetic field. There is also provided a method of separating particles using the magnet device.

The invention relates to a magnet apparatus, particularly to a magnet apparatus for generating a high gradient and/or high strength magnetic field and in some examples for separation of particles.

Magnetic devices are used in various industries, and different applications require different characteristics for the magnetic field. In a number of instances it is an advantage to provide a magnet apparatus that generates a high gradient magnetic field. One advantageous use of a high gradient magnetic field is for separation of particles, and in particular particles of materials that have differing paramagnetic and/or diamagnetic properties.

According to a first aspect of the present invention there is provided a magnet apparatus for generating a high gradient and/or high strength magnetic field, the magnet apparatus comprising: a first plurality of magnets disposed in a first layer and generating a first magnetic field, each magnet of the first plurality being adjacent at least one other magnet of the first plurality, wherein each magnet of the first plurality has a magnetic field polarity that is rotated with respect to that of the adjacent magnet of the first plurality; and a second plurality of magnets disposed in a second layer and generating a second magnetic field, each magnet of the second plurality being adjacent a magnet of the first plurality, wherein each magnet of the second plurality has a magnetic field polarity that is rotated with respect to that of the closest magnet of the second plurality; such that the second magnetic field combines with the first magnetic field to create a magnetic field peak having a larger gradient than that of the first magnetic field.

Each magnet of the first plurality may abut another magnet of first plurality such that their surfaces are touching. Each magnet of the second plurality may touch at least one of the magnets of the first plurality. Different magnets of the second plurality may touch different magnets of the first plurality. Magnets of the second plurality need not all touch the same magnet of the first plurality. Magnets described herein as adjacent may be effectively abutting each other, and thus they may be in close enough proximity to function magnetically in a similar way to magnets that are in direct contact. That is, they may be immediately adjacent one another such that they are less than e.g. 0.2 mm (millimetres) apart, less than 0.1 mm apart, or less than 0.05 mm apart. It will therefore be appreciated that magnets described as adjacent have no significant spacing between them. It will also be appreciated that negligible amounts of other material (e.g. adhesive, metal film coating, mountings etc.) may be disposed between the magnets and may have no significant effect on the resulting magnetic field.

Herein magnetic field polarities of magnets may be described as rotated or rotating with respect to the magnetic field polarities of other magnets. The magnetic field polarity of any individual magnet does not change with time but rather is oriented at a different angle to the magnetic field polarity of another magnet. When considering magnets in the layer e.g. from left to right, the magnetic field polarities may be described as rotating as different magnets are considered in sequence. The magnetic field polarity of each magnet in a layer may be rotated with respect to all of the magnets in that layer that it is adjacent to.

The orientation and arrangement of the magnets and their magnetic field polarities is such that a high gradient magnetic field peak is generated. Such a peak may be used for sorting particles, for example magnetic paramagnetic particles or biological particles suspended in a fluid. The second magnetic field may combine with the first magnetic field to create a single magnetic field peak having a larger gradient than that of the first magnetic field (e.g. may create only a single peak). The second magnetic field may combine with the first magnetic field to create a plurality of magnetic field peaks each having a larger gradient than that of the first magnetic field. The magnetic field peaks may define a plurality of potential wells into which particles may settle under the influence of electromagnetic forces of the magnetic field. Since a plurality of peaks are defined by the magnet apparatus, they may be distributed over a wider area than e.g. a single peak. As such particles may be sorted from a greater volume and a greater number of particles can be sorted in a reduced amount of time. For example, a single magnetic field peak may capture and sort particles in the vicinity of the peak. A plurality of peaks may influence and sort particles at a number of locations simultaneously thereby increasing the rate of sorting.

The second magnetic field may combine with the first magnetic field to create a greater number of magnetic field peaks than are otherwise present in the first magnetic field. Thus, the second layer of magnets may modify the first magnet field to increase the number of magnetic field peaks therein. Alternatively, the second magnetic field may augment the magnetic field peaks of the first magnetic field so that there are the same number of peaks, each having a larger gradient than they otherwise would have without the second magnetic field modifying them.

The second magnetic field may combine with the first magnetic field so that each of the peaks of the plurality of magnetic field peaks has a larger amplitude than the first magnetic field. Therefore, the magnetic field generated by the magnet apparatus may have peaks therein with greater gradients and amplitudes than the magnetic field created by the first layer. The amplitude of the magnetic field peaks may be minimized in order to maximise the gradients.

The magnetic field polarity of each magnet of the second plurality in the second layer may be rotated by any suitable angle. The magnetic field polarities may be rotated by between 15 degrees and 180 degrees with respect to that of the closest magnet of the second plurality. The magnetic field polarities may be rotated by between 15 degrees and 165 degrees with respect to that of the closest magnet of the second plurality. The magnetic field polarities may be rotated by less than 180 degrees between adjacent magnets of the second plurality, and may be rotated by less than 180 degrees for all adjacent magnets of the second plurality. The magnetic field polarities may be arranged so that the polarities of adjacent magnets are not parallel (e.g. aligned or anti-aligned). The rotation may be in the same plane between neighbouring magnets of the second plurality. The plane of rotation of the polarities of the second plurality of magnets may be parallel to the plane of rotation of the polarities of the first plurality of magnets. That is, the magnetic field polarities of the magnets in the first and second layers may rotate in the same plane. Alternatively, the plane of rotation of the polarities of the second plurality of magnets may be orthogonal to the plane of rotation of the polarities of the first plurality of magnets.

The magnetic field polarity of each magnet of the second plurality in the second layer may be rotated with respect to that of the closest magnet of the second plurality by a fraction of 360 degrees such that the polarities of sequential magnets in the second layer rotate by 360 degrees. The amount of rotation between neighbouring magnets in the second layer may be the same. The amount of rotation may be predetermined such that after a predetermined sequence of magnets in a layer the orientations of the magnetic field polarities repeat cyclically. For example, the magnetic field polarities may cycle through the orientations 0°, 90°, 180°, 270°, and 360° (i.e. 0°), and then repeat. The magnetic field polarities may cycle through the orientations 45°, 135°, 225°, 350°, and 45°, and repeat.

The magnetic field polarities of the magnets of the second plurality may rotate in sequence through a plurality of full rotations. The second layer may comprise in the order of a hundred magnets and hence may contain multiple magnets at a particular orientation. That is the magnetic field polarities of the magnets may rotate through 360° multiple times from one end of the layer to an opposite end of the layer.

The magnets of the second plurality may be arranged in a Halbach array. A Halbach array is an arrangement of magnets that augments the magnetic field on one side of the array while reducing the field on the other side. It comprises a spatially rotating pattern of magnetisation. That is the magnetic field polarities of neighbouring magnets are rotated with respect to one another.

The magnetic field polarity of each magnet of the first plurality in the first layer may be rotated by any suitable angle. The magnetic field polarities may be rotated by between 15 degrees and 180 degrees with respect to that of the adjacent magnet of the first plurality. The magnetic field polarities may be rotated by between 15 degrees and 165 degrees with respect to that of the closest magnet of the first plurality. The magnetic field polarities may be arranged so that the polarities of adjacent magnets are not parallel (e.g. aligned or anti-aligned). The rotation of the polarity between adjacent magnets of the first plurality may be less than 180 degrees, and may be less than 180 degrees for all adjacent magnets of the first plurality. The rotation may be the same amount between each neighbouring magnet, and may be for example 90°, 45°, or some other suitable angular rotation. The rotation of the magnetic field polarities between neighbouring magnets of the first layer may be less than 45°.

The magnetic field polarities of the magnets in the first layer may all be rotated with respect to one another in the same plane. The magnets of the first layer may be disposed in a Halbach array.

The magnetic field polarity of each magnet of the first plurality in the first layer maybe rotated by 180 degrees with respect to that of the adjacent magnet of the first plurality. That is, the magnetic field polarity between neighbouring magnets may anti-aligned, i.e. defining an open Kittel arrangement.

Each magnet of the second plurality may be adjacent at least one other magnet of the second plurality. As such each magnet of the second plurality may be adjacent both a magnet of the first plurality and a magnet of the second plurality. Magnets the second plurality, other than those disposed at the edge of the second layer, may be adjacent other magnets of the second plurality on opposite sides.

The second layer of magnets may fully cover a surface of the first layer of magnets. For example, an upper surface of the first layer may contact magnet of the second plurality at all positions thereon such that no part of that surface is exposed.

Each magnet of the first plurality may be adjacent a plurality of magnets of the second plurality. Each magnet of the second plurality may be smaller than magnets of the first plurality and hence multiple magnets the second plurality may be adjacent a single magnet of the first plurality. Consequently the magnet apparatus may comprise a greater number of magnets in the second layer than in the first layer.

The polarities of the magnets of first plurality may sequentially rotate through an integer multiple of 360 degrees over a length of the layer. For example if a first magnet in the first layer has a magnetic field polarity oriented at 0° a last magnet disposed on an opposite side of the first layer to the first magnet may also have a magnetic field polarity oriented at 0°. The magnets of the first layer disposed between the first magnet and the last magnet may have magnetic field polarities oriented at a plurality of angles between 0° and 360° such that the magnetic field polarities sequentially rotate through multiple full rotations from one side of the layer to another.

The polarities of the magnets of the first plurality sequentially rotate through an integer multiple of 180 degrees over a length of the layer. For example, if a first magnet in the first layer has a magnetic field polarity oriented 0°, a last magnet disposed on an opposite side of the first layer to the first magnet may have a magnetic field polarity oriented at 180°. The magnets of the first layer disposed between the first magnet and the last magnet may have magnetic field polarities oriented at a plurality of angles between 0° and 360° such as the magnetic field polarities rotate through multiple full rotations from one side of the layer to the other.

The polarities of the magnets of the first plurality may rotate by the same amount between adjacent magnets of the first plurality. The magnetic field polarities of the magnets of the first layer may rotate by a fraction of 360° so that after a predetermined number of sequential magnets the orientation of the polarity may return to the orientation of the initial magnet.

Every predetermined number of magnets of the second layer, the polarities may rotate by more than the average between closest magnets of the second plurality. For example every seventh magnet may have a magnetic field polarity rotated by 180° with respect to the preceding magnet, whereas the first to sixth magnets may have magnetic field polarities rotated by 45° with respect to their proceeding magnets. Alternatively, every predetermined number of magnets of the second layer, the polarities may rotate by less than the average between closest magnets of the second plurality.

The polarities of the magnets of the first plurality may rotate in the same direction as the polarities of the magnets of the second plurality. For example the magnetic field polarities of the magnets in the first layer may rotate in an anticlockwise direction when considered in sequence from left to right and the magnetic field polarities of the magnets in the second layer may rotate an anticlockwise direction when considered in sequence from left to right. Alternatively, the magnetic field polarities of the magnets of both layers may rotate in a clockwise direction when considered in sequence from left to right. In this way, the magnets of the second layer may be understood to guide and often maximise the fields created by the first layer of magnets.

The rotation of the magnetic field polarities of the magnets of the first plurality and/or the magnets of the second plurality may be in the same plane. The plane may be two-dimensional.

The magnet apparatus may comprise a yoke. The yoke may be a type of magnetic shielding. The yoke may be disposed anywhere in the magnet apparatus and may have any shape. The yoke may be a soft magnetic body or plate, and may be placed adjacent the first and/or second layers of magnets. For example, the yoke may be disposed underneath the first and/or second layer magnets of magnets and may act to short circuit the magnetic field. The yoke may shield the surroundings from the first and second layer of magnets. The yoke may increase the field on the opposite side of the magnets. The yoke may be a soft magnetic material, or may comprise other magnets. The yoke may surround the first and second layers of magnets and may expose an outer surface of the second layer. That is, the yoke may surround the whole magnet apparatus except for only one surface thereof.

The magnet apparatus may comprise cladding. The cladding may comprise magnets and may be positioned adjacent the magnets of the first and/or second layers. The cladding may increase the magnetic fields and/or gradients. The cladding may have any form and may comprise layers with different magnetic polarisation directions. The magnetic polarisation directions may be arranged such that the cladding magnets will increase and/or maximize magnetic forces in predetermined areas. The magnetic polarisation of the cladding may be oriented in a direction that is perpendicular to the magnets of the first and/or second layers. The cladding may take the form of masks or additional layers and may have any suitable orientation direction of magnetic polarisation. The cladding may comprise magnets having magnetic field polarities rotated with respect to other magnets of the cladding. The plane of rotation of the magnetic field polarities of the cladding magnets may be any suitable plane, and may be perpendicular to the plane of rotation of the magnetic field polarities of the first and/or second layers.

The magnet apparatus may comprise cladding magnets arranged to focus (e.g. increase) the magnetic field of the first and second pluralities of magnets e.g. towards the centre of the magnet apparatus for improved capture of magnetic particles. The magnet apparatus may comprise cladding magnets arranged to increase the gradient of the magnetic field generated by the first and second pluralities of magnets.

The magnet apparatus may comprise a third plurality of magnets disposed in a third layer, each magnet of the third plurality being adjacent a magnet of the second plurality and disposed on an opposite side of the second layer to the first layer of magnets. Each magnet of the third layer may have a magnetic field polarity rotated with respect that of a closest magnet in the third layer. The magnetic field polarities of the magnets on third layer may rotate from one side of the layer to the other in the same direction and in the same plane as the rotation of magnetic field polarities in the first layer and/or the second layer. Alternatively the magnetic field polarities of the third layer may rotate in a plane which is orthogonal to the plane of rotation of the first layer and/or second layer. The magnetic field polarities of the magnets in the third layer may be rotated by between 15 degrees and 165 degrees with respect to that of the closest magnet of the third plurality. The magnetic field polarities may be rotated by less than 180 degrees between adjacent magnets of the third plurality, and may be rotated by less than 180 degrees for all adjacent magnets of the third plurality. The magnetic field polarities may be arranged so that the polarities of adjacent magnets are not parallel (e.g. aligned or anti-aligned).

The first layer may be a two-dimensional arrangement of magnets, and the first plurality of magnets may be a first row of the first layer, and the first layer may comprise a plurality of columns, each column comprising a respective plurality of adjacent magnets. The columns of the first layer may be perpendicular to the rows of the first layer. To accommodate this, the magnets of the first layer may have a regular quadrilateral shape. Therefore each magnet of the first layer may belong to both row and a column of the first layer.

Each magnet of a column of the first layer may be adjacent at least one other magnet of the column, and each magnet of the column may have a magnetic field polarity that is rotated with respect to that of the adjacent magnet of the column.

The first layer may therefore comprise a rectangular array of adjacent magnets. If there are as many magnets in each column as there are magnets in each row then the first layer may comprise a square array of magnets.

The magnetic field polarities of the magnets of the first layer may be rotated with respect to adjacent magnets is the same row, and with respect to adjacent magnets in the same column. Thus all magnets in the layer may have a magnetic field polarity rotated with respect to that of its immediate neighbours in a row, and with respect to its immediate neighbours in a column.

The magnetic field polarities of magnets in a column of the first layer may sequentially rotate in the same way as described above in relation to the first plurality of magnets.

The second layer may be a two-dimensional arrangement of magnets, and the second plurality of magnets may be a first row of the second layer, and the second layer may comprise a plurality of columns each column comprising a respective plurality of magnets. The magnetic field pluralities of the magnets in each column of the second layer may rotate with respect to the magnetic field pluralities of neighbouring magnets in the column as described above in relation to the second plurality of magnets.

Each magnet of a column of the second layer may be adjacent at least one other magnet of the column, and each magnet of the column may have a magnetic field polarity that is rotated with respect to that of the adjacent magnet of the column. The magnetic field polarity of each magnet may be rotated with respect to all adjacent magnets in the column.

The magnet device may therefore generate a plurality of magnetic field peaks and troughs distributed over a predetermined area. It may therefore be used to sort particles in a predefined area as described above. The magnetic field peaks and troughs may be evenly distributed over the predetermined area.

The first and second layers may be planar. The first and second layers may be curved. The first plurality of magnets may form a closed loop, and the second plurality of magnets may be disposed therein. The first and second layers may be concentric circles.

The magnets may be permanent magnets. The magnets may have any shape suitable for being arranged as described herein. The magnet apparatus may comprise soft magnetic material in the layers. The magnet apparatus may comprise a plurality of layers. The magnet apparatus may be arranged so that in use the second layer is disposed between the first layer and the particles and/or material to be separated. The magnet apparatus may be arranged so that in use the particles and/or materials to be sorted are disposed in the direction in which the pluralities of magnets are layered (e.g. the second layer may be above the first layer, and the particles to be sorted may be above the second layer i.e. in the direction of layering).

According to a second aspect of the present invention there is provided a method of separation of particles comprising using a magnet apparatus as described above in relation to the first aspect, and exposing the particles to be separated to the magnetic field generated by the apparatus.

The method may comprise separating magnetic or paramagnetic particles, and/or may comprise separating biological material suspended in a fluid. The method may comprise arranging the magnet apparatus so that in use the second layer is disposed between the first layer and the particles and/or material to be separated. Therefore, in use, the first layer may be further from the particles and/or material to be separated than is the second layer. The second layer may be disposed above the first layer, and the particles and/or material to be sorted may be disposed above the second layer.

Certain embodiments of the invention will now be described by way of example only and with reference to the accompanying drawings in which:

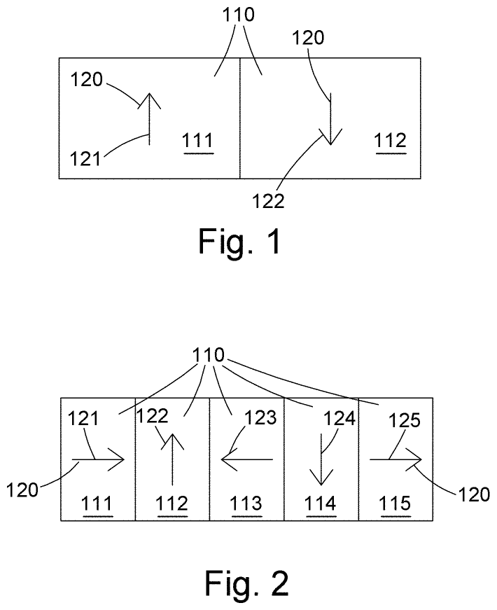

FIG. 1 shows an open Kittel arrangement of magnets;

FIG. 2 shows a Halbach array of magnets;

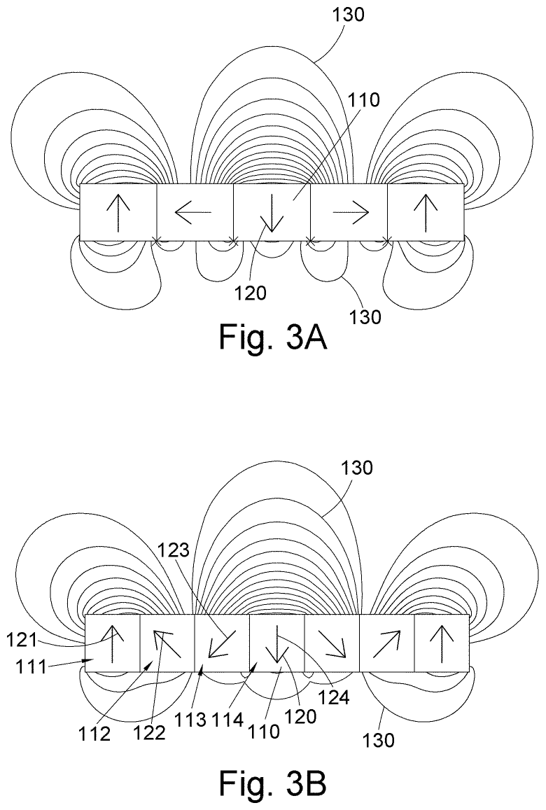

FIG. 3A shows a Halbach array of magnets and the resulting magnetic field lines;

FIG. 3B shows a Halbach array of magnets and the resulting magnetic field lines;

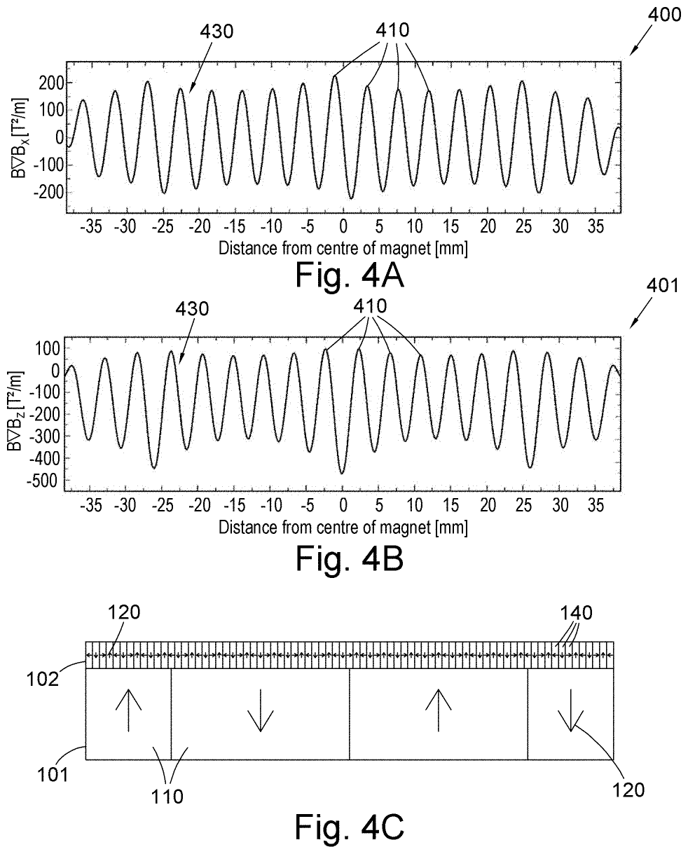

FIG. 4A shows a graph of a component of the magnetic force generated by a magnet apparatus shown in FIG. 4C;

FIG. 4B shows a graph of a component of the magnetic force generated by a magnet apparatus shown in FIG. 4C;

FIG. 4C shows a magnet apparatus for generating a plurality of magnetic force peaks;

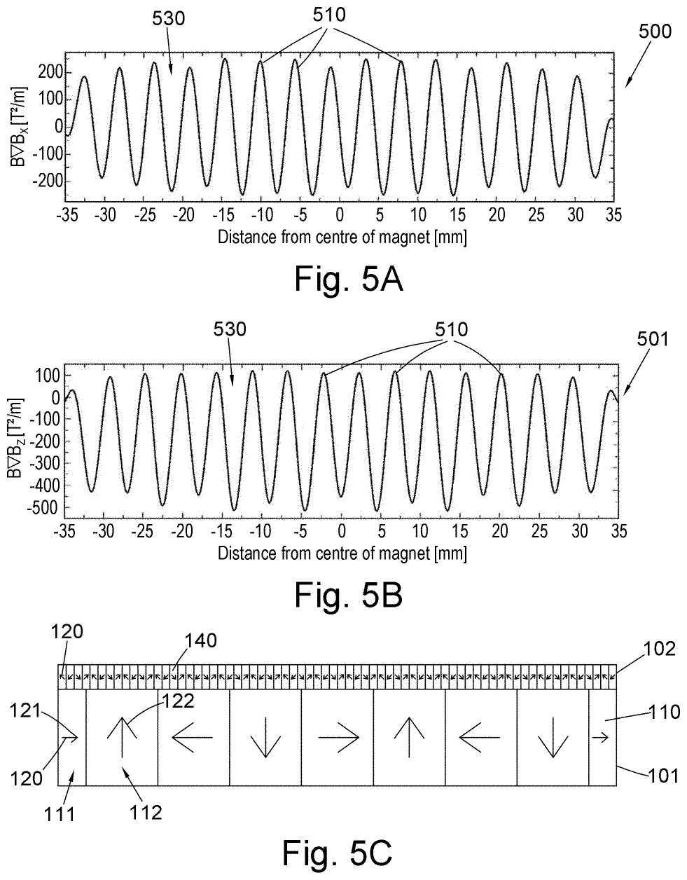

FIG. 5A shows a graph of a component of the magnetic force generated by a magnet apparatus shown in FIG. 5C;

FIG. 5B shows a graph of a component of the magnetic force generated by a magnet apparatus shown in FIG. 5C;

FIG. 5C shows a magnet apparatus for generating a plurality of magnetic force peaks;

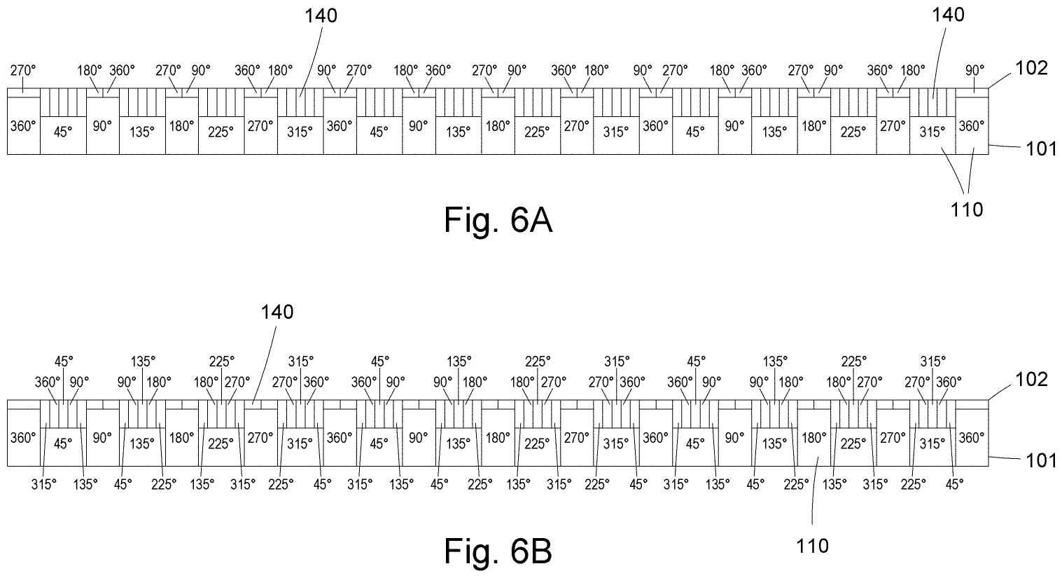

FIG. 6A shows a magnet apparatus with the angle of the magnetic field polarity for some magnets;

FIG. 6B shows the magnet apparatus of FIG. 6A with the angle of the magnetic field polarity for the other magnet;

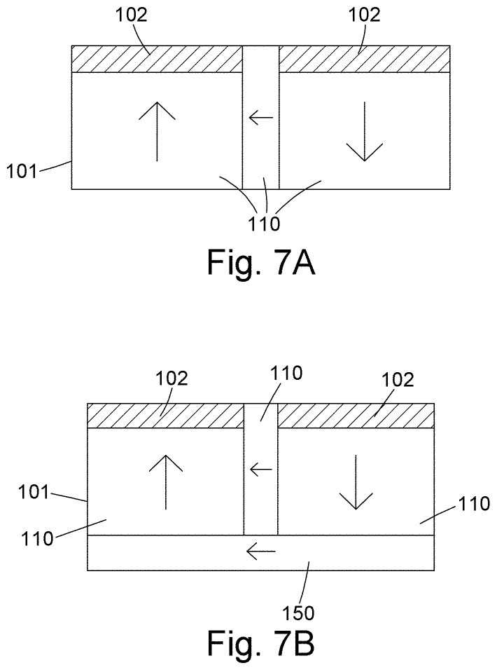

FIG. 7A shows another magnet apparatus for generating a plurality of magnetic field peaks;

FIG. 7B shows an adaptation of the magnet apparatus of FIG. 7A;

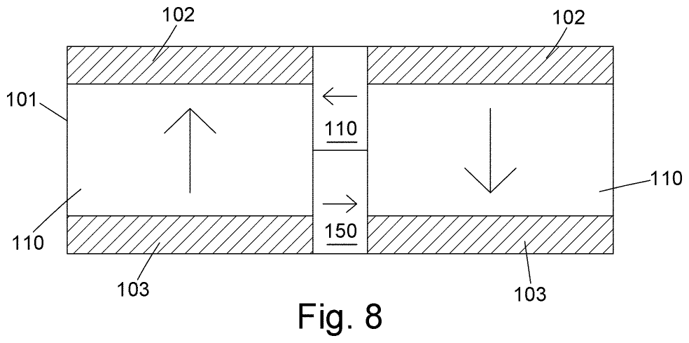

FIG. 8 shows another magnet apparatus for generating a plurality of magnetic field peaks on two sides of the apparatus;

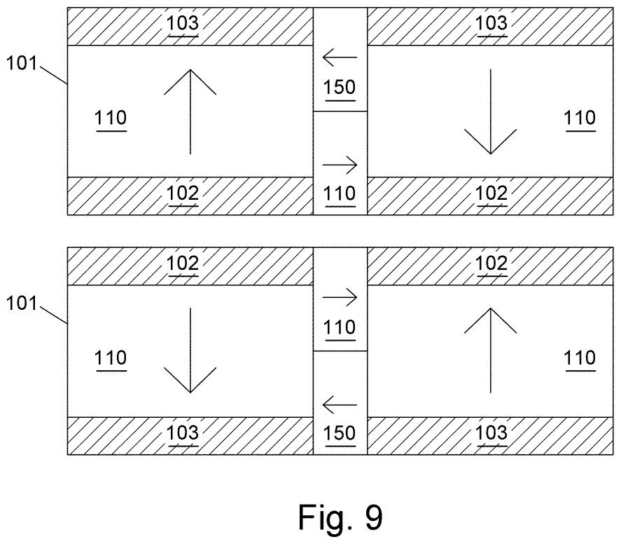

FIG. 9 shows another magnet apparatus for generating a plurality of magnetic field peaks;

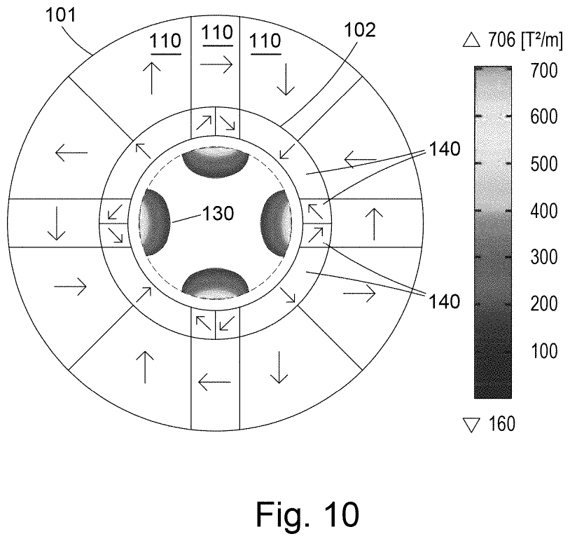

FIG. 10 shows another magnet apparatus for generating a plurality of magnetic field peaks, having circular concentric layers of magnets;

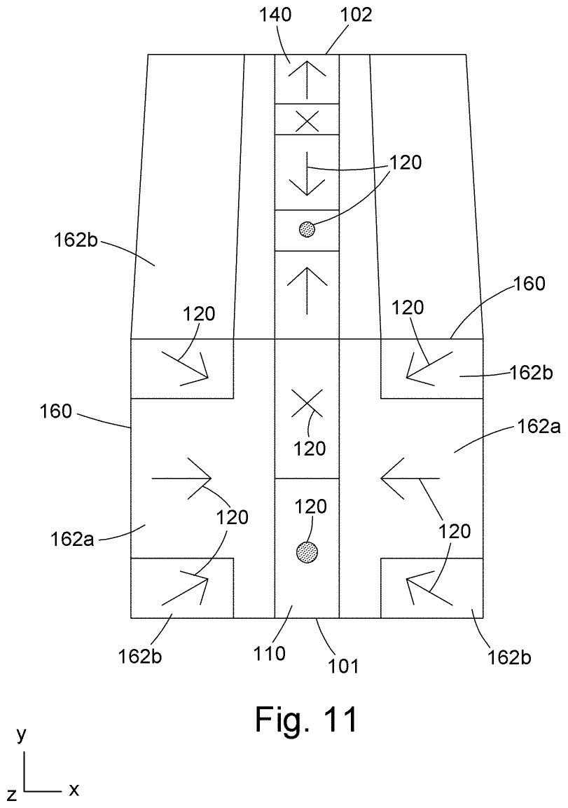

FIG. 11 shows a magnet apparatus comprising cladding;

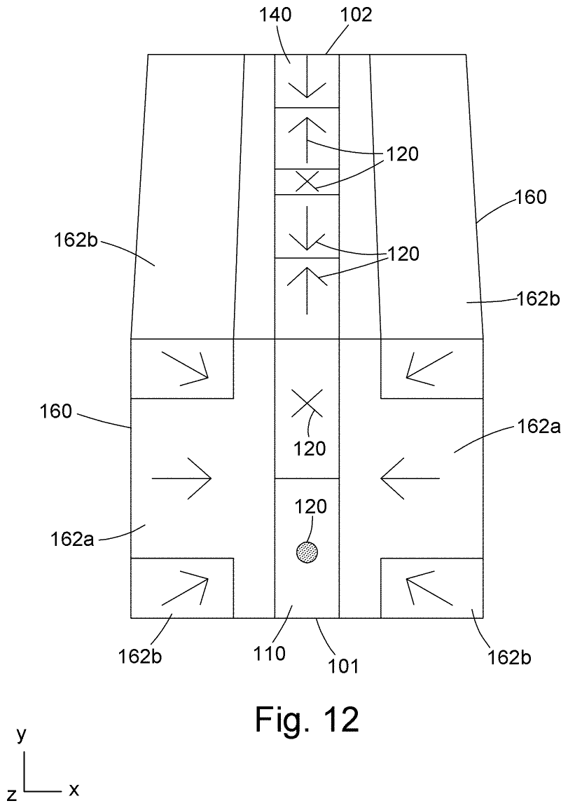

FIG. 12 shows another magnet apparatus comprising cladding; and

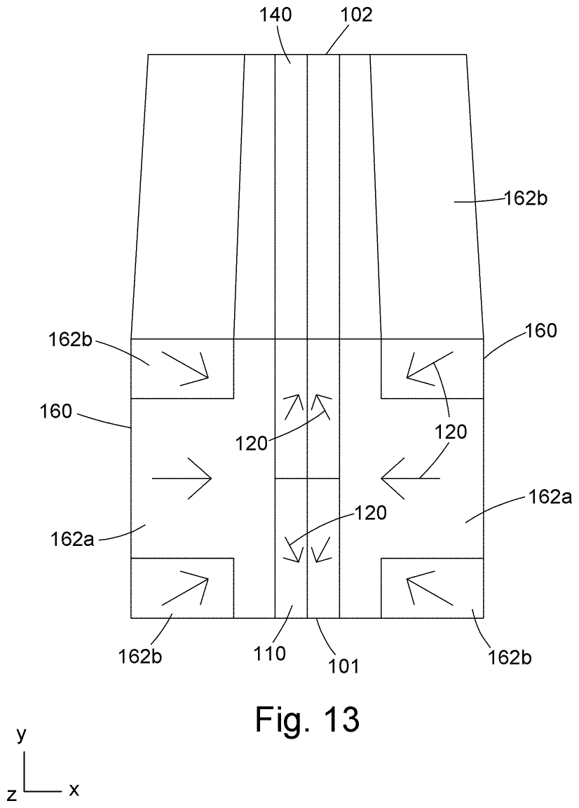

FIG. 13 shows another magnet apparatus comprising cladding.

FIG. 1 shows two magnets in open Kittel arrangement. The arrangement comprises two magnets 110, each having a magnetic field polarity 120. The first magnet 111 has a magnetic field polarity 121 oriented vertically upwards and the second magnet 112 has a magnetic field polarity 122 anti-aligned with that of the first magnet 111 i.e. vertically downwards. An open Kittel arrangement comprises adjacent magnets 110 adjacent one another with magnetic field polarities 120 anti-aligned between adjacent magnets 110.

FIG. 2 shows five magnets 110 arranged in a Halbach array. A Halbach array is an arrangement of magnets 110 that augments the magnetic field 130 on one side of the array while reducing the magnetic field 130 on the other side by having a spatially rotating pattern of magnetisation. In FIG. 2, the first magnet 111 has a magnetic field polarity 121 oriented at 0°. The first magnet 111 is adjacent/abuts the second magnet 112 which has a magnetic field polarity 122 rotated with respect to that of the first magnet 111 and disposed at an angle of 90°. The second magnet 112 is adjacent/abuts a third magnet 113 which has a magnetic field polarity 123 rotated with respect to that of the second magnet 112. The magnetic field polarity 123 of the third magnet 113 is oriented at 180°. A fourth magnet 114 is adjacent/abuts the third magnet 113 and has a magnetic field polarity 124 rotated with respect to the magnetic field polarity 123 of the third magnet 113. The magnetic field polarity 124 of the fourth magnet 114 is oriented at 270°. A fifth magnet 115 has a magnetic field polarity 125 rotated with respect to the magnetic field polarity 124 of the fourth magnet 114. The magnetic field polarity 125 of the fifth magnet 115 is oriented at 360° i.e. 0°.

The magnetic field polarities 120 of the magnets 110 in the depicted Halbach array of FIG. 2 are each rotated with respect to the immediately adjacent and abutting magnets 110. The magnetic field polarities 120 are rotated in the same plane. They are each rotated sequentially by the same angle, in this case 90°. As such, the magnetic field polarity 125 of the fifth magnet 115 has the same orientation as that of the first magnet 111.

It will be appreciated that although the orientations of the magnetic field polarities 120 are described herein using a right horizontal alignment as 0°, this is done merely for convenience and the orientation of the 0° line may be defined otherwise, e.g. vertically upwards (at what is presently 90°). The same angular rotation will exist between abutting magnets 110 regardless of the co-ordinates used to describe them. For example, the alignments of the magnetic field polarities 120 could be described using radians e.g. 0 rad, π/2 rad, π rad, 3π/2 rad, and 2π rad respectively for the first to fifth magnets 110 of FIG. 2.

FIG. 3A shows a Halbach array together with a schematic representation of the resulting magnetic field 130 indicated by lines of magnetic potential. The magnetic field polarities 120 of the magnets 110 are rotated sequentially by 90° in a clockwise direction moving from left to right. Each of the magnetic field polarities 120 is rotated in the same direction with respect to that of the preceding magnet 110 moving from left to right. Consequently, the magnetic fields of each of the magnets 110 combine to create the magnetic field 130. Below the array the magnetic field 130 is augmented while the magnetic field 130 above the array is reduced.

FIG. 3B shows another Halbach array of magnets 110 each having a magnetic field polarity 120. In the case depicted in FIG. 3B, a first magnet 111 has a magnetic field polarity 121 oriented vertically upwards. A second magnet 112 is adjacent and abutting the first magnet 111, and has a magnetic field polarity 122 which is rotated by 45° anti-clockwise with respect to the magnetic field polarity 121 of the first magnet 111. A third magnet 113 abuts the second magnet 112 on a side opposite the first magnet 111, and has a magnetic field polarity rotated with respect to the second magnetic field polarity 122 by 90° in an anti-clockwise direction. A fourth magnet 114 abuts the third magnet 113 on a side opposite to the second magnet 112 and has a magnetic field polarity 124 which is rotated by 45° in an anti-clockwise direction with respect to the magnetic field polarity 123 of third magnet 113.

Therefore, in FIG. 3B, while the magnetic field polarities 120 all sequentially rotate in the same direction with respect to the preceding magnetic field polarity 120 (when moving from left to right), they do not rotate by the same amount between all neighbouring magnets 110. Between the first magnet 111 and the second magnet 112, the magnetic field polarities 120 rotate by 45°. Between the second magnet 112 and the third magnet 113 the magnetic field polarities 120 rotate by 90°. The magnetic field polarities 120 therefore sequentially rotate by different amounts between neighbouring magnets. In the case depicted in FIG. 3B the orientations of the magnetic field polarities 120 are symmetric about the fourth magnet 114.

The magnetic fields of the magnets 110 in the example shown in FIG. 3B combine to create a magnetic field 130 that is stronger above the Halbach array (i.e. augmented above the array) and is weaker below the array (i.e. reduced below the array).

FIG. 4C shows a magnet apparatus comprising a first plurality of magnets 110 disposed in a first layer 101 and a second plurality of magnets 140 disposed in a second layer 102 on top of the first layer 101. The second layer 102 of magnets 140 comprises a Halbach array wherein the magnetic field polarity 120 of each of the magnets 140 is rotated by 90° in an anticlockwise direction with respect to that of the preceding magnet 140. Moving from the leftmost end of the second layer 102 of magnets 140 to the rightmost end, the magnetic field polarities 120 of the magnets 140 of the second layer 102 rotate repeatedly through 360°. The second layer 102 therefore comprises a plurality of magnets 140 with magnetic field polarities 120 oriented at 0°, a plurality of magnets 140 with magnetic field polarities 120 oriented at 90°, plurality of magnets 140 with magnetic field polarities 120 oriented at 180°, and a plurality of magnets 140 with magnetic field polarities 120 oriented at 270°.

First layer of magnets 110 shown in FIG. 4C is an open Kittel arrangement. As such, the magnetic field polarities 120 of the magnets 110 are anti-aligned with their immediate neighbours (i.e. are rotated by 180°).

The magnets 140 of the second layer 102 are smaller than those of the first plurality of magnets 110 in the first layer 101. Each of the magnets 140 is adjacent/abuts at least one magnet 110 of the first layer 101, and is adjacent/abuts at least one magnet 140 of the second layer 102. The magnetic fields of the magnets 140 interact with the magnetic fields of the magnets 110 to provide a magnetic field comprising a plurality of peaks.

The magnetic force resulting from the magnet apparatus is shown in the graphs 400 and 401 in FIGS. 4A and 4B respectively. The graph 400 shows the force in the x-direction (parallel to the surface of the magnet device) and the graph 401 shows the magnetic force in the z-direction (perpendicular to the surface of the magnet device). The forces are measured along the surface of the magnet device, 1 mm above it. A plurality of peaks 410 is visible in the magnetic force 430 formed by the magnet apparatus. The peaks 410 have a higher gradient than would the magnetic field of the first layer 101 of magnets 110 alone. The peaks 410 also have a greater amplitude than would the magnetic field of the first layer 101 of magnets 110 alone. The maximum force in the graphs in FIGS. 4A, 4B is at the bottom of the peaks 410, e.g. around −200 T²/m in FIG. 4A.

FIG. 5C shows another magnet apparatus comprising a first layer 101 of magnets 110 and a second layer 102 of magnets 140 disposed on the first layer 101. The magnets 110 of the first layer 101 are arranged in a Halbach array. Their magnetisation is spatially rotated with respect to magnets 110 in the preceding position in the layer. A first magnet 111 of the first layer 102 has a magnetic field polarisation 120 oriented at 0°. A second magnet 112 of the first layer 102 abuts the first magnet 111 and has a magnetic field polarisation 122 that is rotated by 90° in an anticlockwise direction with respect to the magnetic field polarisation 121 of the first magnet 111 of the first layer 101.

The magnetic field polarisations 120 of the magnets 110 of the first layer 101 rotate sequentially by 90° in an anticlockwise direction with respect to their preceding neighbour moving from left to right. The magnetic field polarisations 120 of the magnets of the first layer 101 rotate plurality of times through 360°.

The magnets 140 of the second layer 102 are disposed atop the first layer 101 and fully cover an upper surface. Each magnet 140 of the second layer 102 is adjacent/abuts at least one other magnet 140 of the second layer 102. The second layer 102 magnets 140 also comprises Halbach array. The magnetic field polarisations 120 of the magnets 140 of the second layer 102 rotate sequentially by 90° between neighbouring magnets 140. The magnetic field polarisations 120 of the magnets 140 of the second layer 102 sequentially cycle through full rotations of 360° and have angles of 135°, 225°, 315°, and 45°.

Graphs 500 and 501 is shown in FIGS. 5A and 5B depict different components of the magnetic force 530 generated by the magnet apparatus. The graph 500 shows the force in the x-direction (parallel to the surface of the magnet device) and the graph 501 shows the magnetic force in the z-direction (perpendicular to the surface of the magnet device). The forces are measured along the surface of the magnet device, 1 mm above it. The magnetic force 530 comprises a plurality of field peaks 510 each having gradients greater than that of a magnetic field generated by the first layer 101 alone. Each magnetic field peak 510 also has an amplitude greater than that of a magnetic field formed by the first layer of magnets 110 alone. The maximum force in the graphs in FIGS. 5A, 5B is at the bottom of the peaks 510, e.g. around −200 T²/m in FIG. 5A.

The magnetic field polarities 120 of the magnets 110 in the first layer 101 rotate sequentially in an anticlockwise direction from left to right. The magnetic field polarities 120 of the magnets 140 in the second layer 102 also rotate in anticlockwise direction from left to right. That is, the magnetic field polarities 120 of the magnets 110 and the magnets 140 rotate in the same direction.

It can be seen from FIGS. 4A-C and 5A-C that the magnet apparatuses shown therein provide a plurality of high gradient peaks 410, 510 in the magnetic force. These peaks 410, 510 may be used for sorting particles such as magnetic or paramagnetic particles and/or biological material.

FIG. 6A shows a magnet apparatus comprising a first layer 101 of magnets 110 and the second layer 102 of magnets 140 wherein the angular orientation of the magnetic field polarity 120 of the magnets 110 in the first layer are indicated together with the angular orientation of the magnetic field polarities 120 of some of the magnets 140 in the second layer 102. FIG. 6B shows the same magnet apparatus as that of FIG. 6A, and shows the angular orientation of the magnetic field polarities 120 of the magnets 140 in the second layer 102 which are not shown in FIG. 6A.

The magnets 110 of the first layer 101 have alternating heights. The magnets 140 of the second layer 102 also have alternating heights and abut the magnets 110 of the first layer 101 such that a top layer of the magnet apparatus is flat.

The magnetic field polarities 120 of the magnets 110 in the first layer 101 rotate by 45° between abutting magnets 110. The magnetic field polarities 120 rotate in an anticlockwise direction, the same as that of the magnets 140 of the second layer 102. While the magnetic field polarities 120 of the magnets 110 in the first layer 101 rotate by the same amount between neighbouring magnets, the magnetic field polarities 120 of the magnets 140 in the second layer 102 may rotate by different amounts between neighbouring magnets in that layer. For example, every seventh magnet 140 of the second layer has a magnetic field polarity 120 anti-aligned with that of the preceding magnet. The other of the magnets 140 in the second layer 102 have magnetic field polarities 120 rotated by 45° with respect to the preceding magnet 140. Despite the difference in amount of rotation, the magnetic field polarities 120 of the magnets 140 in the second layer 102 rotate in an anticlockwise direction with respect to the preceding magnet 140.

The magnetic field polarities 120 of the magnets 110 in the first layer 101 rotate in the same direction (moving from left to right) as the magnetic field polarities 120 of the magnets 140 in the second layer 102.

A magnetic field resulting from the magnet apparatus comprises a plurality of high gradient and high amplitude magnetic field peaks. As such, the magnet apparatus of FIGS. 6A and 6B may be used for sorting particles.

FIG. 7A shows another magnet apparatus comprising a first layer 101 and a second layer 102. The first layer 101 comprises magnets 110 of the first plurality and the second layer 120 comprises magnets 140 of the second plurality. The details of the magnets 140 in the second layer 102 are not shown in FIG. 7A for the sake of clarity and it will be understood that they may be arranged in any suitable manner as described above in relation to the second layer 102.

In FIG. 7A, the first layer 101 comprises three magnets 110 and the second layer 102 comprises a plurality of magnets 140 disposed on top of and touching magnets 110 of the first layer 101. The central magnet 110 of the first layer 101 is narrower and taller than the other two magnets 110 of the first layer 101 and bisects the second layer 102, so that the second layer comprises pluralities of magnets either side of the central magnet 110 of the first layer 101. Thus, in FIG. 7A the second layer 102 is positioned atop two of the magnets 110 of the first layer 101.

FIG. 7B shows the same arrangement as that of FIG. 7A, and further includes an additional magnet 150 disposed below the first layer 101 and contacting all of the magnets 110 thereof.

FIG. 8 shows another magnet apparatus comprising a first layer 101 of magnets 110, and a second layer 102 of magnets 140. The details of the second layer 102 of magnets 140 are not shown, but it will be appreciated that the second layer 102 comprises any suitable arrangement of a plurality of magnets 140 as described above. The central magnet 110 of the first layer 101 bisects the second layer 102 and hence divides the second layer 102 into two pluralities of magnets, each disposed on top of and touching a magnet 110 of the first layer 101.

The magnet apparatus of FIG. 8 also comprises an additional magnet 150 embedded within the first layer 101, as well as third layer of magnets 103. The third layer 103 comprises a plurality of magnets in any arrangement which is the same as that of the second layer 102. The details of this arrangement are not shown in FIG. 8, but it will be appreciated that the third layer 103 may comprise any and all of the features of the second layer 102. The additional magnet 150 bisects the third layer 103 so that a plurality of magnets are disposed either side of the additional magnet 150, and beneath and touching magnets 110 of the first layer 101.

It is clear from FIG. 8 that the magnet apparatus therein is symmetric. That is, it is invariant when rotated upside down. The first layer 101 has been defined as comprising the upper of two central magnets, and the additional magnet 150 has been defined as the lower of those two central magnets. However, it will be appreciated that because of the symmetry, the first layer 101 might instead be defined to include the lower of the two central magnets (i.e. the ‘additional magnet 150’ as shown in FIG. 8), and the upper of the central magnets may be defined at the additional magnet.

Due to its symmetry, the magnet apparatus of FIG. 8 generates a plurality of magnetic field peaks on both sides the magnet device, both above and below (in the orientation of FIG. 8).

FIG. 9 shows a symmetric apparatus comprising two sets of magnets, each set arranged similarly to the apparatus of FIG. 8, albeit one set arranged symmetrically from the other (the symmetry being about the centre of the arrangement).

FIG. 10 shows a magnet apparatus wherein the first layer 101 and second layer 102 are circular layers arranged concentrically, rather than being planar layers as per the apparatus of e.g. FIGS. 4C, 5C. 6A and 6B. A magnetic force is generated within the centre of the magnet arrangement and comprises a plurality of magnetic field peaks and a magnetic field trough. The tubular arrangement of FIG. 10 may be useful in cases where a planar magnet apparatus is not suitable.

FIG. 11 shows a magnet apparatus comprising a first layer 101 comprising a first plurality of magnets 110, and a second layer 102 comprising a second plurality of magnets 140. The first layer 101 of magnets 110 and second layer 102 of magnets 140 may have any arrangement as described herein. The first layer 101 and second layer 102 each comprise magnets 110, 140 which have magnetic field polarities 120 which are rotated with respect to adjacent magnets in the same layer.

The magnet apparatus of FIG. 11 also comprises cladding 160 disposed both sides of and adjacent the first and second layers 101, 102. The cladding 160 comprises cladding magnets 162. The cladding magnets 162 each have a magnetic field polarity 120 which is rotated with respect to adjacent cladding magnets 162. In the apparatus of FIG. 11, on each side of the cladding 160 comprises a first cladding magnet 162a adjacent to both the first and second layers 101, 102, and two second cladding magnets 162b, set into corresponding recesses of the first cladding magnet 162a. The magnetic field polarity 120 of each of the second cladding magnets 162b is rotated with respect to that of the first cladding magnet 162a. The plane or rotation of the magnetic field polarities 120 of the cladding magnets 162 is perpendicular to the plane of rotation of the magnetic field polarities 120 of the first plurality of magnets 110, and to the plane of rotation of the magnetic field polarities of the second plurality of magnets 140.

In the magnet apparatus of FIG. 11, the magnets 110 and 140 of the first and second layers 101, 102 produce the force that in use will gather magnetic particles. This force is in the y-direction (upwards in the figure) and may be called the magnetic capturing force. The magnets 110, 140 will concentrate the particles in areas where the magnetic capturing forces are the largest.

The first cladding magnets 162a on both sides of the first and second layers 101, 102 focus the fields towards the centre and the magnets of the first and second layers. In other embodiments, the first cladding magnet 162a may be split in to a plurality of cladding magnets with other magnetization directions. Each cladding magnet 162 may be arranged to focus the magnetic field towards the centre of the magnet apparatus.

The second cladding magnets 162b have magnetic field polarisations 120 directed inwardly of the magnet device. The second cladding magnets 162b modify the magnetic fields of the magnet apparatus to increase the gradient in the y-direction. The increased gradient may improve the capturing ability of the magnet apparatus for magnetic particles. The second cladding magnets 162b may be omitted in order to simplify manufacture, but their inclusion is preferred due to their effect of increasing the gradient of the magnetic field. Each second cladding magnet 162b may be divided into a plurality of second cladding magnets 162b if required.

FIG. 12 shows a magnet apparatus comprising cladding 160 similar to that of FIG. 11. The first layer 101 of magnets 110 and second layer 102 of magnets 140 may have any arrangement as described herein. Each side of the cladding 160 of FIG. 12 comprises a first cladding magnet 162a and two second cladding magnets 162b as described above with reference to FIG. 11. Although the arrangements of the magnets 110 in the first layer 101 and the arrangement of the magnets 140 in the second layer 102 are different to the arrangement of the corresponding magnets of FIG. 11, the first cladding magnets 162a and second cladding magnets 162b have a similar effect of focussing the magnetic field towards the centre of the magnet apparatus and increasing the gradient of the magnetic field in the y-direction.

FIG. 13 shows a magnet apparatus comprising cladding 160, wherein the rotation of the magnetic field polarities 120 of the magnets 110 of the first layer 101 and the magnets 140 of the second layer is in the same plane as the rotation of the magnetic field polarities 120 of the cladding magnets 162.

In use, the magnets 110 and 140 of the magnet apparatus of FIG. 13 will create a magnetic field such that a line of separated particles are collected along the length of the magnet apparatus (in the z-direction). The force in the depicted arrangement may be relatively small because the magnetic field is relatively homogeneous in this direction.

In use, the magnet apparatuses of FIGS. 11 and 12 may provide a larger force in the z-direction than does the apparatus of FIG. 13. In this way, different versions of the magnet apparatus may be adapted to be better at some applications than others.

1. A magnet apparatus for generating at least one from the group consisting of a high gradient and high strength magnetic field, the magnet apparatus comprising:
a first plurality of magnets disposed in a first layer and generating a first magnetic field, each magnet of the first plurality being adjacent at least one other magnet of the first plurality, wherein each magnet of the first plurality has a magnetic field polarity that is rotated with respect to that of the adjacent magnet of the first plurality; and
a second plurality of magnets disposed in a second layer and generating a second magnetic field, each magnet of the second plurality being adjacent a magnet of the first plurality, wherein each magnet of the second plurality has a magnetic field polarity that is rotated with respect to that of the closest magnet of the second plurality,
such that the second magnetic field combines with the first magnetic field to create a magnetic field peak having a larger gradient than that of the first magnetic field.

2. The magnet apparatus of claim 1, wherein the second magnetic field combines with the first magnetic field to create a plurality of magnetic field peaks each having a larger gradient than that of the first magnetic field.

3. The magnet apparatus of claim 1, wherein the magnetic field polarity of each magnet of the second plurality in the second layer is rotated by between 15 degrees and 180 degrees with respect to that of the closest magnet of the second plurality.

4. The magnet apparatus of claim 1, wherein the magnetic field polarity of each magnet of the second plurality in the second layer is rotated with respect to that of the closest magnet of the second plurality by a fraction of 360 degrees such that the polarities of sequential magnets in the second layer rotate by 360 degrees.

5. The magnet apparatus of claim 1, wherein the magnetic field polarities of the magnets of the second plurality rotate in sequence through a plurality of full rotations.

6. The magnet apparatus of claim 1, wherein the magnets of the second plurality are arranged in a Halbach array.

7. The magnet apparatus of claim 1, wherein at least one from the group consisting of the magnetic field polarity of each magnet of the first plurality in the first layer is rotated by between 15 degrees and 180 degrees with respect to that of the adjacent magnet of the first plurality and the magnetic field polarity of each magnet of the first plurality in the first layer is rotated by 180 degrees with respect to that of the adjacent magnet of the first plurality.

8. (canceled)

9. The magnet apparatus of claim 1, wherein at least one from the group consisting of each magnet of the second plurality is adjacent at least one other magnet of the second plurality and each magnet of the first plurality of adjacent a plurality of magnets of the second plurality.

10. The magnet apparatus of claim 1, wherein the second layer of magnets fully covers a surface of the first layer of magnets.

11. (canceled)

12. The magnet apparatus of claim 1, wherein at least one from the group consisting of the polarities of the magnets of first plurality sequentially rotate through an integer multiple of 360 degrees over a length of the layer and the polarities of the magnets of the first plurality sequentially rotate through an integer multiple of 180 degrees over a length of the layer.

13. (canceled)

14. The magnet apparatus of claim 1, wherein the polarities of the magnets of the first plurality rotate by the same amount between adjacent magnets of the first plurality.

15. The magnet apparatus of claim 1, wherein every predetermined number of magnets of the second layer the polarities rotate by more than the average between closest magnets of the second plurality.

16. The magnet apparatus of claim 1, wherein polarities of the magnets of the first plurality rotate in the same direction as the polarities of the magnets of the second plurality.

17. The magnet apparatus of claim 1, wherein the rotation of magnetic field polarities of the magnets of at least one from the group consisting of the first plurality and magnets of the second plurality, is in the same plane.

18. The magnet apparatus of claim 1, comprising a yoke surrounding the first and second layers of magnets and exposing an outer surface of the second layer.

19. The magnet apparatus of claim 1, comprising cladding comprising magnets positioned adjacent the magnets of at least one from the group consisting of the first and the second layers, the cladding magnets being arranged to at least one from the group consisting of increase the magnetic field of the first plurality of magnets and second plurality of magnets, and increase the gradient of the magnetic field generated by the first plurality of magnets and second plurality of magnets.

20. (canceled)

21. The magnet apparatus of claim 1, further comprising a third plurality of magnets disposed in a third layer, each magnet of the third plurality adjacent a magnet of the second plurality and disposed on an opposite side of the second layer to the first layer of magnets.

22. The magnet apparatus of claim 1, wherein the first layer is a two-dimensional arrangement of magnets, wherein the first plurality of magnets is a first row of the first layer, and wherein the first layer comprises a plurality of columns each column comprising a respective plurality of adjacent magnets, each magnet of a column of the first layer being adjacent at least one other magnet of the column, and wherein each magnet of the column has a magnetic field polarity that is rotated with respect to that of the adjacent magnet of the column.

23. (canceled)

24. The magnet apparatus of claim 22, wherein the second layer is a two-dimensional arrangement of magnets, wherein the second plurality of magnets is a first row of the second layer, and wherein the second layer comprises a plurality of columns each column comprising a respective plurality of adjacent magnets, each magnet of a column of the second layer is adjacent at least one other magnet of the column, and wherein each magnet of the column has a magnetic field polarity that is rotated with respect to that of the adjacent magnet of the column.

25. (canceled)

26. The magnet apparatus of claim 1, wherein the first plurality of magnets forms a closed loop, and wherein the second plurality of magnets is disposed thereabout.

27. (canceled)

28. (canceled)

29. (canceled)
